(19) United States
(12) Patent Application Publication
(10) Pub. No.: US 2014/0007127 A1
(43) Pub. Date: Jan. 2, 2014

(54) PROJECT MANAGEMENT SYSTEM AND METHOD

(71) Applicants: Gidi Amir, Ness Ziona (IL); Noam shaham, Mazkeret (IL); Ron Maurer, Haifa (IL); Ron Banner, yokneam (IL); Mani Fischer, Haifa (IL); Carl Staelin, Haifa (IL); Doron Shaked, Haifa (IL); Renato Keshet, Haifa (IL)

(72) Inventors: Gidi Amir, Ness Ziona (IL); Noam shaham, Mazkeret (IL); Ron Maurer, Haifa (IL); Ron Banner, yokneam (IL); Mani Fischer, Haifa (IL); Carl Staelin, Haifa (IL); Doron Shaked, Haifa (IL); Renato Keshet, Haifa (IL)

(21) Appl. No.: 14/002,571

(22) PCT Filed: Mar. 3, 2011
(86) PCT No.: PCT/US11/26985

§ 371 Date: Aug. 30, 2013

(51) Int. Cl. G06F 9/50

(52) U.S. Cl. CPC G06F 9/5005
USPC 718/104

(57) ABSTRACT

A project management system (10) and method (250) are included. The project management system (10) includes a production database (14) in memory (15) to store project data (20). The project data (20) can include workflow resource data (16) describing workflow resources (54, 56) and feedback data (17) obtained for each workflow step (52) of a plurality of projects (18) of a project type (152). The project management system (10) also includes a processor (27) to access the memory (15) and to execute computer readable instructions including a production learning module (26) to analyze the workflow resource data (16) and the feedback data (17) to generate predictive project data (12). The predictive project data (12) can describe a predicted workflow (154) for a given project (18) of the project type (152) based on the workflow resources (54, 56).

### BACKGROUND

Manufacturing and industrial process systems can be complex, with a level of complexity that is typically commensurate with a level of complexity of the resulting projects. Thus, it may be difficult to manage and track the status of workflows of projects that are being implemented on a given production floor. As an example, a given production floor environment may be established for manufacturing products corresponding to a large number of different types of projects, with many products being manufactured substantially concurrently at different stages of a workflow. Managing such projects and project types can utilize computerized tools, but such management may require the entry of large amounts of data over extended periods of time. In addition, some data may be difficult to ascertain by individuals responsible for such data entry. Thus, efficient optimization of project management may be difficult.

### BRIEF DESCRIPTION OF THE DRAWINGS

FIG. 1 illustrates an example of a project management system according to an embodiment.

FIG. 2 illustrates an example of a project workflow system according to an embodiment.

FIG. 3 illustrates an example of a production database according to an embodiment.

FIG. 4 illustrates an example of predictive project data according to an embodiment.

FIG. 5 illustrates an example of a production learning module according to an embodiment.

FIG. 6 illustrates an example of a method for generating predictive project data according to an embodiment.

### DETAILED DESCRIPTION

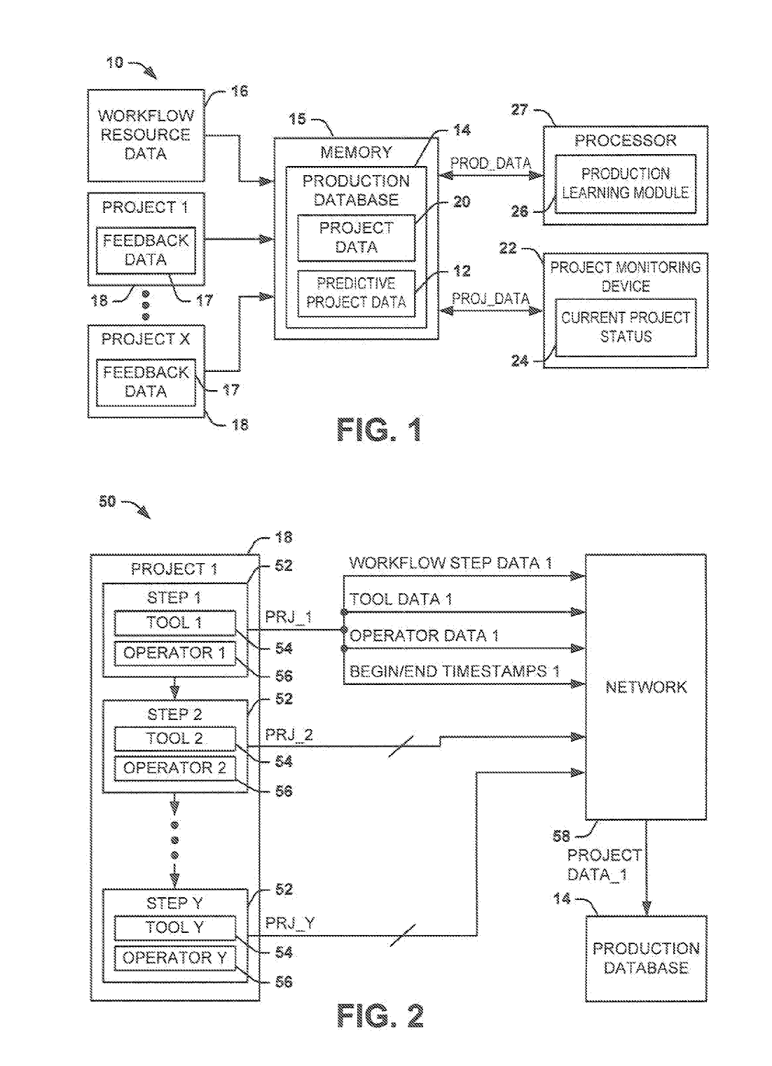

FIG. 1 illustrates an example of a project management system 10. The project management system 10 can be implemented in a manufacturing/service environment for any of a variety of manufacturing and/or service providers, such as for a print service provider (PSP) that can handle a large range of digital solutions for a large number of customers. The project management system 10 can be configured to generate predictive project data 12 associated with a predicted workflow for each of a plurality of project types based on available workflow resources, such as human operators, tools, and their associated characteristics. The predictive project data 12 can thus be implemented for efficiently scheduling and managing projects in the manufacturing/service environment.

The project management system 10 intrudes a production database 14. The production database 14 can be stored as machine readable data in a memory 15, such as on a server or other computer. The production database 14 is configured to receive and store workflow resource data 16 and feedback data 17 associated with each of a plurality X of projects 18, where X is a positive integer. As an example, the workflow resource data 16 can be associated with available workflow resources in the production environment, such as eligible human operators, tools, and inventory, in the example of FIG. 1, the stored workflow resource data 16 and the feedback data 17 is collectively demonstrated as a set of project data 20 stored in the production database 14. Thus, the production database 14 stores the workflow resource data 16 and the feedback data 17 of each of the projects 18 as information that indicates available workflow resources and the status of each of the projects 18.

The projects 18 can each be separate and independent projects that are of one of a plurality of different project types that can be implemented in the manufacturing and/or service environment associated with the project management system 10. Each of the different project types associated with the projects 18 can have different associated workflows that can be utilized for completing the respective projects 18, with each of the workflows employing a different sequence of stages or steps. Each step of the workflow can thus include separate workflow resources that are implemented for completing the respective step of the workflow. As an example, the workflow resources can include one or more tools for completing the respective workflow step. Workflow resources can also include one or more human operators that can operate the respective tools of the workflow step. As a result the feedback data 17 can include information that identifies the tools, human operators, and time involved for each of the respective workflow steps for each of the projects 18.

FIG. 2 illustrates an example of a project workflow system 50. The project workflow system 50 can be associated with the project management system 10 in the example of FIG. 1. Therefore, reference is to be made to the example of FIG. 1 in the following description of the example of FIG. 2.

The project workflow system 50 includes a plurality Y of workflow steps 52 associated with a respective project 18, where Y is a positive integer. In the example of FIG. 2, the project 18 is demonstrated as “PROJECT 1” and the workflow steps 52 are demonstrated as “STEP 1” through “STEP Y”. Thus, each of the workflow steps 52 can be one of a plurality of sequential operations to be implemented for completion of the project 18. As a result, each of the workflow steps 52 includes a tool 54 and a human operator 56 that are employed to implement the respective workflow step 52. As an example, in a PSP environment, the tool 54 could be any of a variety of PSP tools, such as printers, folding machines, trimming machines, binding machines, or any of a variety of other types of print service machines. It is to be understood that the tool 54 can represent any of a variety of production units and/or departments, such as a transportation department or a finishing department. It is also to be understood and appreciated that each of the workflow steps 52 is not limited to including a single tool 54 and single operator 56, but could omit one of the tool 54 or operator 56, or could include more than one tool 54 and/or operator 56.

At each of the workflow steps 52, a set of feedback data associated with the workflow step 52 can be provided to the production database 14 via a network 58. As an example, the network 58 could be a focal area network (LAN), or could be a wide area network (WAN), such as the internet. In the example of FIG. 2, the feedback data for each workflow step 52 is demonstrated as “PRJ_{—}1” through “PRJ_Y”. As an example, the operator 56 can operate one or more input devices that can allow the operator to provide some or all of the feedback data for the respective workflow step 52. For example, the operator 56 can manually enter the feedback data via a computer terminal, can operate a barcode scanner, can swipe a magnetic card or radio-frequency Identification (RFID) tag, and/or provide the feedback data for the respective workflow step 52 in any of a variety of other ways. As another example, at least a portion of the feedback data of the workflow step 52 can be provided automatically by the respective tool 54 during implementation of the workflow step 52. For example, the fool 54 can be directly coupled to the network 58, such that the tool 54 can log the relevant feedback data to the production database 14 automatically via the network 58 as it performs its respective functions for the respective workflow step 52.

In the example of FIG. 2, the feedback data associated with respective workflow step 52 is demonstrated as including workflow step data, tool data, operator data, and beginning and ending timestamps. As an example, the workflow step data can be identification data associated with the workflow step 52 itself, such as including a unique identifier for the respective project 18 and/or data that connects the workflow step 52 with the project 18. As another example, the tool data can be data associated with the tool 54 that implements the respective workflow step 52, such as including a unique identifier corresponding to the respective unique tool 54, an identifier corresponding to the type of tool 54, or a combination of the two. As yet another example, the operator data from a given workflow step 52 can be data associated with the operator 56 that operates the tool 54 in the respective workflow step 52, such as a unique identifier corresponding to the operator 56, and can include other data associated with the operator 56, such as qualifications, certifications, and/or preferences. As a further example, the beginning and ending timestamps can be timestamps that simply correspond to the times of commencing and finishing each respective workflow step 52. The logging of the beginning timestamp could be combined with the workflow step data, such as to indicate the commencement of the workflow step 52 when the workflow step data is provided to the production database 14.

Thus, at each of the workflow steps 52, a separate set of feedback data corresponding to the respective workflow step 52 is provided to the production database 14. It is to be understood that, while the example of the feedback data “PRJ_{—}1” corresponding to the workflow step 52 is demonstrated as including the types of feedback data described above, the feedback data for the other workflow steps 52 can include more, less, or different elements of feedback data associated with the respective workflow step 52. Therefore, the collective sets of feedback data of each of the workflow steps 52 corresponds to a set of feedback data 17 for the project 18 itself demonstrated in the example of FIG. 2 as “PROJECT DATA_{—}1” provided from the network 58 to the production database 14. Accordingly, the feedback data 17 for all of the projects 18 can be provided to the production database 14 to be saved in the production database 14 as part of the set of project data 20, along with the workflow resource data 16, in the example of FIG. 1.

Referring hack to the example of FIG. 1, the project management system 10 also includes one or more project monitoring devices 22 that are configured to display current project status 24 associated with each of the projects 18 in real-time. In the example of FIG. 1, the set of project data 20 is demonstrated as being provided to the project monitoring device(s) 22 via a signal PROJ_DATA. As an example, the project monitoring device(s) 22 can include one or more video monitors, computer screens, personal digital assistants (PDAs), tablet personal computers (PCs), or a variety of other display devices that can display the current project status 24 for one or more of the projects 18 as the projects 18 are completed in real-time. For example, the current project status 24 can include status associated with each workflow step of one or more of the projects 18, and can be arranged in strategic locations within the manufacturing and/or service environment, such as to display the current project status 24 for projects 18 that are being completed more proximal to a given one of a plurality of project monitoring devices 22 or provided to a portable device carried by an operator 56. Accordingly, human operators and/or project managers can be provided with sufficient information regarding the projects 18 as they are completed.

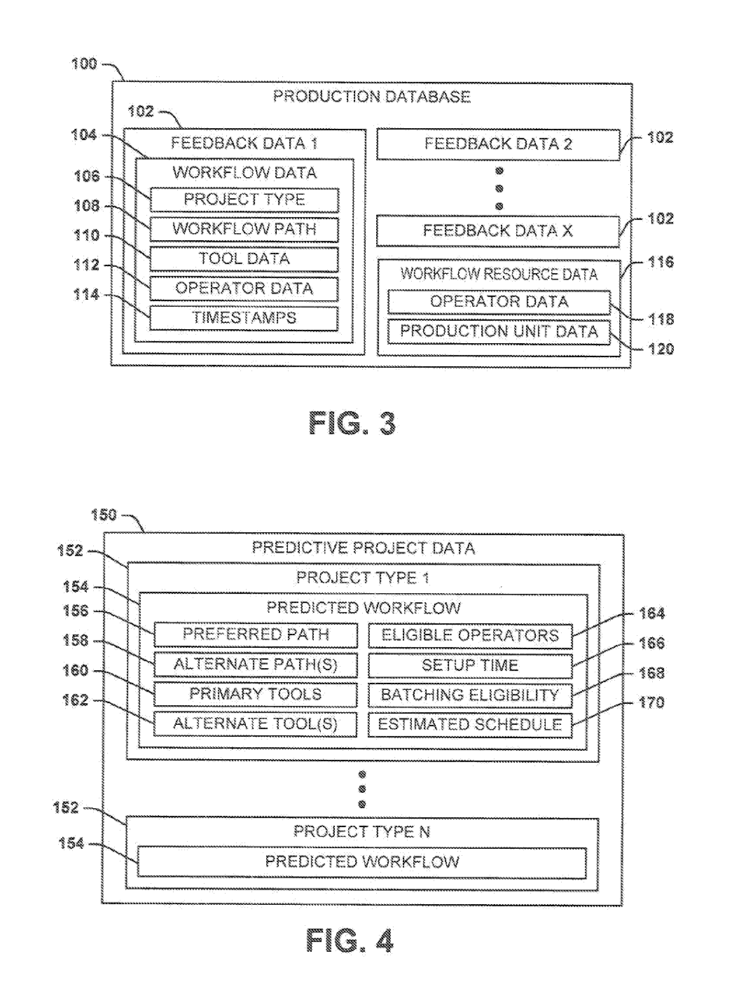

FIG. 3 illustrates an example of a production database 100. The production database 100 can be configured substantially similar to the production database 14 in the example of FIG. 1, and includes a plurality X sets of feedback data 102, demonstrated in the example of FIG. 3 as “FEEDBACK DATA 1” through “FEEDBACK DATA X”. The sets of feedback data 102 can each correspond respectively to the projects 18 in the example of FIG. 1. Therefore, reference is to be made to the examples of FIGS. 1 and 2 in the following description of the example of FIG. 3.

Each of the sets of feedback data 102 can include workflow data 104 associated with the respective project 18, such as data associated with the workflow steps 52 in the example of FIG. 1. As an example, the workflow data 104 can include substantially all of the data associated with each of the workflow steps 52, and thus substantially all aspects of the respective project 18. The workflow data 104 can include project type data 106 corresponding to the type of project of the corresponding project 18, and can include data associated with the parameters of the project 18. For example, in the context of a PSP, the project type data 106 can indicate whether the project 18 is a set of stapled papers, books, or brochures, and can include information regarding the type of paper used, the number of pages, and other information regarding the specific details of the project 18.

The workflow data 104 can also include workflow path data 108, tool data 110, operator data 112, and timestamps 114. The workflow path data 108 can be associated with each of the workflow steps 52. For example, the workflow path data 108 can include the workflow step data from each of the workflow steps 52 in the example of FIG. 2. Thus, the workflow path data 108 includes data associated with the specific workflow path and corresponding steps that are implemented in completion of the respective project 18. The tool data 110 can be associated with each of the tools 54 that are implemented in the respective workflow steps 52. The operator data 112 can be associated with each of the operators 56 at each of the workflow steps 52 that operate the respective tools 54. The timestamps 114 can be associated with the timestamps that corresponding to the times of commencing and finishing each of the workflow steps 52, and/or any other pertinent timestamps, such as for shift changes and lunch breaks that can interrupt a given workflow step. It is to be understood that the timestamps 114 could be part of the workflow path data 108. In addition, it is to be understood that the set of feedback data 102 for a given project 18 can include one or more sub-projects, each of which can include its own workflow steps and associated tools and operators. For example, a hard-cover book can include two sub-projects: one for the production of the hard-cover binding and one for the production of the inner pages (i.e., book block), such that at a certain step of the overall project, the two sub-projects are combined and proceed to a next workflow step of the overall project.

The production database 100 also includes workflow resource data 116, which can correspond to the workflow resource data 16 in the example of FIG. 1. The workflow resource data 116 can include data associated with available workflow resources for the production environment. In the example of FIG. 3, the workflow resource data 116 includes operator data 118 and production unit data 120. The operator data 118 can include a-priori known data associated with all of the eligible human operators and/or staff associated with the production environment, as well as pertinent data about them. For example, the operator data 118 can include data associated with names, ID numbers, regular work schedules, human resource information, training, certifications, and/or tool preferences of the operators of the production environment. Similarly, the production unit data 120 can include a-priori known data associated with all types of production units, such as tools and inventory, in the production environment, as well as pertinent data about them. For example, the production unit data 120 can include data associated with functions, status, maintenance schedules, and/or other information regarding the fools of the production environment, as well as current inventory and re-supply points for the inventory.

It is to be understood that the production database 100 is not limited to being arranged as demonstrated in the example of FIG. 3. As an example, the production database 100 could include a plurality of databases that are each configured to store different sets of the collective feedback data 102 for each of the projects 18. For example, the production database 100 could include separate databases each corresponding to project history (e.g., project type 106, workflow path 108, and timestamps 114), tool data 110, and operator data 112, respectively, with each of the separate databases being organized by project 18. As another example, the production database 100 could include separate databases for each of the feedback data 102 and the workflow resource data 118. Thus, the production database 100 can be configured in a variety of ways.

Referring back to the example of FIG. 1, the project management system 10 also includes a production learning module 26. As an example, the production learning module 26 can be configured as machine readable instructions (e.g., as software or firmware component) within a processor 27, as hardware, or as a combination of hardware and machine readable instructions, and can be co-located with or separate from the production database 14. The production learning module 26 can be configured to statistically analyze the set of project data 20 stored in the production database 14 and can generate the predictive project data 12 based on the analysis. As an example, the analysis can be statistical, such as based on averages, standard deviations, or other statistical bases. The predictive project data 12 can be associated with a predicted workflow for each of a plurality of project types based on available workflow resources, as indicated in the set of project data 20. In addition, the predictive project data 12 can include production units performance data and resource related data, such as ascertained based on an analysis of the workflow resource data 16. The predictive project data 12 can thus be implemented for efficiently scheduling and managing future projects in the manufacturing/service environment in which the project management system 10 is implemented.

As an example, the production learning module 26 can identify the data in the set of project data 20 associated with each of the projects 18 that correspond to each specific type of project. The production learning module 28 can then analyze all of the data corresponding to all of the projects 18 to generate a predicted workflow for each of the project types, with the set of predicted workflows corresponding to the predictive project data 12. The predicted workflows can thus be workflows for future projects 18 of the respective specific project types based on the available resources that are indicated by the set of project data 20 (e.g., based on the workflow resource data 16). In addition, the predicted workflow can change based on other future projects that are scheduled substantially concurrently, and are thus required to share the available resources indicated by the set of project data 20. Furthermore, the generation of the predictive project data 12 can likewise by dynamic, such that it can change based on future feedback data 17. As an example, upon generating predicted workflows for respective project types, the production learning module 26 can provide real-time changes to the predicted workflows, and thus the predictive project data 12, based on changes to the available resources, as indicated by feedback data 17 that is provided to the production database 14. Accordingly, the predictive project data 12 substantially continuously evolves based on changes to the set of project data 20. Thus, a predicted workflow of the predictive project data 12 can be implemented for a new project that is introduced in the project management system 10 based a similarity of the new project's type to the other projects in the production database 14.

FIG. 4 illustrates an example of predictive project data 150. The predictive project data 150 can correspond to the predictive project data 12 in the example of FIG. 1. Therefore, reference is to be made to the examples of FIGS. 1 through 3 in the following description of the example of FIG. 4.

The predictive project data 150 includes data for a plurality N of project types 152, where N is a positive integer. Each of the project types 152 includes a predicted workflow 154 corresponding to the efficient predicted workflow for future projects 18 of the respective project types 152. The predicted workflow 154 for each of the project types 152 includes data associated with a preferred path 156 and one or more alternate paths 158. The preferred path 156 can correspond to a preferred set of workflow steps 52 from initiation to completion of the respective project. As an example, the statistical analysis of the set of project data 20 can result in a preferred path 156 of the workflow steps 52 that has a highest probability of a most efficient completion of a project 18 of the respective project type 152, such as based on an aggregate of the workflow path data 108 for a given project type 152.

The alternate paths 158 can thus correspond to alternative workflow steps 52 that can be implemented instead of one or more of the workflow steps 52 of the preferred path 156. As an example, alternate paths 158 can be determined by the production learning module 26 based on less frequently selected redundant workflow steps 52 for a given project type, or redundant workflow steps 52 that may be less efficient than other workflow steps 52 of the same or substantially similar types. One or more of the alternate paths 158 can thus be implemented in the predicted workflow 154 to provide greater flexibility for the scheduling of multiple projects 18, such as when one or more of the workflow steps 52 of the multiple projects 18 would overlap. Therefore, one or more alternate paths 158 can be selected for a project 18 to be scheduled. Such alternate paths may provide a slightly decreased efficiency of the respective project 18 (e.g., by selecting the one or more alternate paths 158 as deviations from the preferred path 156), but can result in an increase in overall efficiency of multiple projects 18 to be scheduled.

The predicted workflow predicted workflow 154 for each of the project types 152 also includes data associated with primary tools 160 and one or more alternate tools 162. Similar to as described above regarding the preferred and alternate paths 156 and 158, the primary tools 160 can correspond to a preferred one or more tools 54 for each workflow step 52 in the predicted workflow 154, and alternate tool(s) 162 can correspond to one or more redundant alternative tools 54 for a given one or more workflow steps 52. In addition, the data associated with the primary and alternate tools 160 and 162 can correspond to performance data associated with the primary and alternate fools 160 and 162. It is to be understood that the data associated with primary tools 160 and alternate tool(s) 162 could be incorporated with the data associated with the preferred and alternate paths 156 and 158, respectively.

In addition, the predicted workflow 154 also includes a list of eligible operators 164 that correspond to the operation of the tools 54 of each of the workflow steps 52. The data associated with the eligible operators 164 can be based on feedback data which shows an association of the operator with certain tools and certain project types, qualifications, experience, and/or certifications of the operators 56, as well as relative speed and efficiency of operation, as determined by the operator feedback data 112 and/or the operator data 118, and can include regular work schedules and tool preferences of the operators 56. Furthermore, the data associated with the eligible operators 164 can include performance data associated with the eligible operators and/or staff of the production environment. Thus, the eligible operators 164 can be associated with a set of operators 56 and/or staff that can result in a most efficient workflow of the project type 152, including a list of alternative operators and/or staff for each of the workflow steps 52. Accordingly, the eligible operators 164 can be used to schedule the future projects 18 efficiently with respect to the operator resources that are available.

The predicted workflow 154 also includes data associated with setup time 166. The setup time 166 can be associated with each tool and can be based on an analysis of the feedback data timestamps 114 across several projects. The setup time 166 can include a setup matrix corresponding to predicted setup times of the tools 54 for each of the workflow steps 52, such as based on average setup times of each of the fools 54. The setup matrix can thus describe a given tool's setup time required for a transition from any type of project to any other type of project, such as determined by the feedback data timestamps 114. The setup time 166 can also include an indication of preference of job queuing by the operators 56 at a given workflow step 52, such that the setup time 166 can be most efficient with respect to the operators 56 and/or can be provided to ensure operator efficiency.

The predicted workflow 154 further includes data associated with batching eligibility 168. For example, the feedback data 17 and/or the time stamps 114 for a given workflow step 52 can indicate that workflow steps 52 can be associated with different projects 18, even of different project types between setup of the respective tool(s) 56, such as indicated by the timestamps 114 and/or the setup time 166. Thus, the workflow steps 52 of the respective projects 18 were batched together, thus allowing the production learning module 26 to learn which types of workflow steps 52 of different types of projects 18 can be batched together. Therefore, the batching eligibility 168 can be information associated with the eligibility of each workflow step 52 to be combined with workflow steps 52 of other project types 152, such that projects 18 can be scheduled most efficiently by batching together workflow steps 52 that are compatible for batching based on the batching eligibility 168.

The setup time 166, as well as the timestamps 114 stored in the production database 100, can be implemented by the production learning module 26 to generate an estimated schedule 170 corresponding to an estimated amount of time for each of the workflow steps 52 for each project type 152. The estimated schedule 170 can thus be dynamic based on the preferred and alternate path(s) 156 and 158, as well as the primary and any alternate tool(s) 160 and 162, and can be used to schedule projects 18 and to determine overlap of given workflow steps 52 of the scheduled projects 18.

Accordingly, the predictive project data 150 can be implemented for scheduling future projects in a most efficient manner for each different project type 152. The production learning module 26 can utilize the predictive project data 150 to determine optimal scheduling for a number of projects 18 that are to be concurrently scheduled, such that the predictive project data 150 can be dynamically determinative of the predicted workflows 152 based on the types and number of projects 18 to be scheduled and available resources. For example, the predicted workflow 154 of a project 18 having a given project type 152 can change based on the scheduling of another project 18 having the same or a different project type 152, such that the predicted workflows 154 of the projects 18 are collectively most efficient for substantially concurrent or overlapping implementation. As an example, such scheduling and generation of the predicted workflows 154 can be performed by the production learning module 26 based on a number of different types of recursive algorithms, such as genetic algorithms. As a result, the production learning module 26 can be configured to automatically learn the most efficient manner in which to generate the predictive project data 150 for most efficient schedule of projects in a manufacturing and/or service environment.

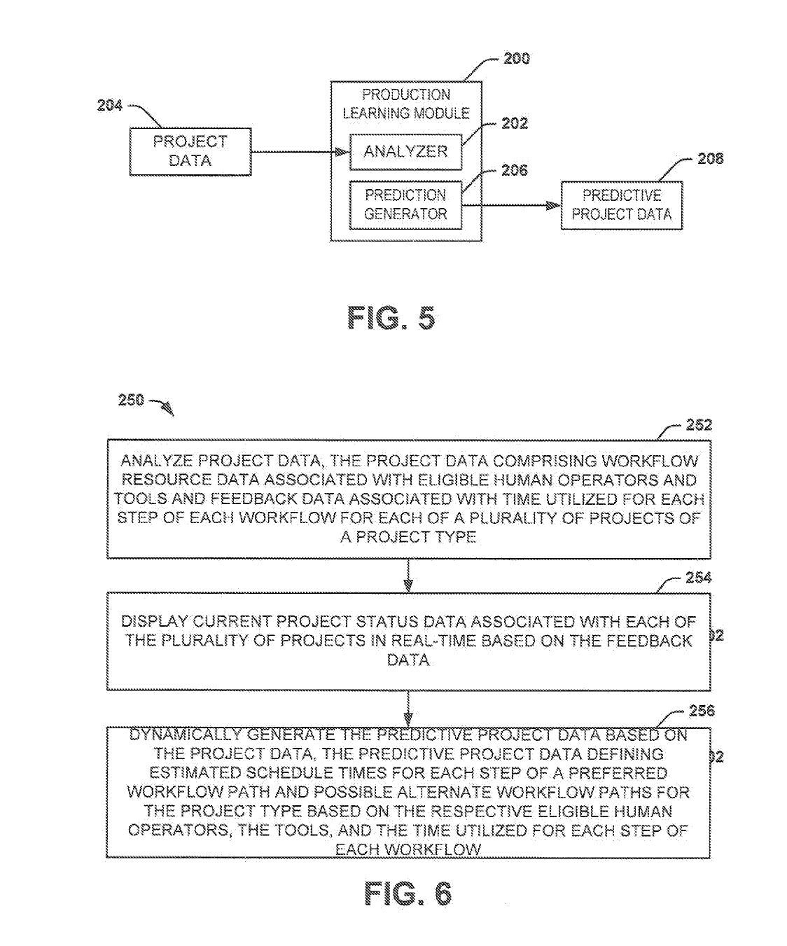

FIG. 5 illustrates an example of a production learning module 200. The production learning module 200 can correspond to the production learning module 26 in the example of FIG. 1. Thus, reference can be made to the example of FIG. 1 in the following description of the example of FIG. 5.

The production learning module 200 includes an analyzer 202 that is configured to analyze project data 204. The project data 204 can include workflow resource data describing workflow resources and feedback data associated with each of a plurality of projects of a project type. For instance, the project data 204 can correspond to the project data 20 in the example of FIG. 1. The production learning module 200 also includes a prediction generator 206 configured to dynamically generate predictive project data 208 based on the analysis of the project data 204. The predictive project data 208 can define estimated schedule times for each step of a preferred workflow path and possible alternate workflow paths for the project type based on the workflow resources. For example, the predictive project data 208 can correspond to the predictive project data 12 and 150 in the examples of FIGS. 1 and 4, respectively.

As a further example, the analyzer 202 and the prediction generator 206 can be implemented as instructions of a non-transitory computer readable medium. As an example, one or both of the analyzer 202 and the prediction generator 206 can corresponding to the installation files stored in a computer readable medium, such as an optical disk or a remote storage from which they can be downloaded and installed. Alternatively or additionally, one or both of the analyzer 202 and the prediction generator 206 can be stored in memory of a computer, such as a server.

In view of the foregoing structural and functional features described above, an example method will be better appreciated with reference to FIG. 6. While, for purposes of simplicity of explanation, the method of FIG. 6 is shown and described as executing serially, it is to be understood and appreciated that the method is not limited by the illustrated order, as parts of the method could occur in different orders and/or concurrently from that shown and described herein.

FIG. 6 illustrates an example of a method 250 for generating predictive project data. At 252, project data comprising workflow resource data associated with eligible human operators and tools and feedback data associated with each of a plurality of projects of a project type is analyzed. At 254, current project status data associated with each of the plurality of projects is displayed in real-time based on the feedback data. At 256, the predictive project data is dynamically generated based on the project data, the predictive project data defining estimated schedule times for each step of a preferred workflow path and possible alternate workflow paths for the project type based on the respective eligible human operators, the tools, and the time utilized for each step of each workflow.

What have been described above are examples. It is, of course, not possible to describe every conceivable combination of components or methodologies, but one of ordinary skill in the art will recognize that many further combinations and permutations are possible. Accordingly, the invention is intended to embrace all such alterations, modifications, and variations that fall within the scope of this application, including the appended claims. As used herein, the term “includes” means includes but not limited to, the term “including” means including but hot limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements.

1. A project management system comprising:
a production database in memory to store project data, the project data comprising workflow resource data describing workflow resources and feedback data obtained for each workflow step of a plurality of projects of a project type; and
a processor to access the memory and to execute computer readable instructions comprising a production learning module to analyze the workflow resource data and the feedback data to generate predictive project data, the predictive project data describing a predicted workflow for a future project of the project type based on the workflow resources.

2. The system of claim 1, wherein one of the plurality of workflow resources comprises a human operator associated with a step of a given workflow associated with a respective one of the plurality of projects, and wherein at least a portion of the feedback data is provided via a network to the production database in real-time by the human operator concurrently with a respective step of the given workflow.

3. The system of claim 1, wherein one of the plurality of workflow resources comprises a tool associated with a step of a given workflow associated with a respective one of the plurality of projects, and wherein at least a portion of the feedback data is provided via a network to the production database in real-time by the tool concurrently with the respective step of the given workflow.

4. The system of claim 1, wherein the production learning module is to dynamically modify the predictive project data in real-time based on feedback data that is subsequently provided to the production database.

5. The system of claim 1, further comprising a project monitoring device to display current project status data associated with each of a plurality of projects in real-time based on the feedback data.

6. The system of claim 1, wherein the workflow resource data comprises data associated with a plurality of human operators and a plurality of production tools, and wherein the feedback data comprises at least one of start and stop times of a given workflow step of a respective one of the plurality of projects.

7. The system of claim 1, wherein for the project type, the predictive project data comprising at least one of:
a preferred workflow path and possible alternate workflow paths for the predicted workflow;
a list of preferred tools and possible alternate tools associated with each step of the preferred workflow path and the possible alternate workflow paths;
a list of eligible human operators associated with each step of the preferred workflow path and the possible alternate workflow paths;
batching eligibility data associated with combining each step of the preferred workflow path and the possible alternate workflow paths with steps of a workflow path associated with another project;
setup times associated with transitions of the list of preferred and possible alternate tools between each step of the preferred workflow path and the possible alternate workflow paths of the project type based on start and stop times of the plurality of projects; and
estimated schedule times associated with each step of the preferred workflow path and the possible alternate workflow paths based on the start and stop times of the plurality of projects and the setup times.

8. A print service-provider (PSP) to implement the project management system of claim 1.

9. A non-transitory machine readable medium having machine readable instructions comprising:
an analyzer to analyze project data, the project data comprising workflow resource data describing workflow resources and feedback data associated with each of a plurality of projects of a project type; and
a prediction generator to dynamically generate predictive project data based on the analysis of the project data, the predictive project data defining estimated schedule times for each step of a preferred workflow path and possible alternate workflow paths for a future project of the project type based on the workflow resources.

10. The machine readable medium of claim 9, wherein at least a portion of the feedback data is provided via a network to the production database in real-time by the human operator concurrently with the respective step of each workflow.

11. The machine readable medium of claim 9, wherein the at least a portion of the feedback data is provided via a network to the production database in real-time by a tool concurrently with the respective step of each workflow.

12. The machine readable medium of claim 9, wherein the predictive project data for the project type comprises at least one of:
data describing a preferred workflow path and possible alternate workflow paths for the predicted most-efficient workflow;
data describing preferred tools and any possible alternate tools associated with each step of the preferred workflow path and the possible alternate workflow paths;
data describing eligible human operators associated with each step of the preferred workflow path and the possible alternate workflow paths;
data describing batching eligibility data associated with combining each step of the preferred workflow path and the possible alternate workflow paths with steps of a workflow path associated with another project;
data describing setup times associated with transitions of the list of preferred and possible alternate tools between each step of the preferred workflow path and the possible alternate workflow paths of the project type based on start and stop times of the plurality of projects; and
data describing estimated schedule times associated with each step of the preferred workflow path and the possible alternate workflow paths based on the start and stop times of the plurality of projects and the setup times.

13. A method for generating predictive project data, the method comprising:
analyzing project data, the project data comprising workflow resource data associated with eligible human operators and tools and feedback data associated with time utilized for each step of each workflow for each of a plurality of projects of a project type;
displaying current project status data associated with each of the plurality of projects in real-time based on the feedback data; and
dynamically generating the predictive project data based on the project data, the predictive project data defining estimated schedule times for each step of a preferred workflow path and possible alternate workflow paths for at least one future project of the project type based on the respective eligible human operators, the tools, and the time utilized for each step of each workflow.

14. The method of claim 13, wherein receiving the project data comprises receiving via a network at least a portion of the feedback data in real-time in response to a user input concurrently at each respective step of each workflow.

15. The method of claim 13, wherein receiving the project data comprises receiving at least a portion of the feedback data in real-time from a tool concurrently at each respective step of each workflow via a network.
